(19) United States
(12) Patent Application Publication
(10) Pub. No.: US 2003/0066873 A1
(43) Pub. Date: Apr. 10, 2003

(54) Instrument for computing proportions of an original recipe

(76) Inventor: Eileen Ward, Trenton, NJ (US)

Correspondence Address: William L. Muckelroy, Esq., P.C., Ewing Professional Building, Suite 3A, 1901 N. Olden Avenue, Trenton, NJ, 08618, US

(21) Appl. No.: 09/969,918

(22) Filed: Oct. 3, 2001

(51) Int. Cl. G06C 27/00

(52) U.S. Cl. 235/74

(57) ABSTRACT

A hand-held instrument for calculating the measurements necessary to prepare any number of servings or serving sizes from a printed food recipe which utilizes two concentric rotating wheels, the lower one of the wheels having instructions printed thereon in a 120 degree segment and measurement data thereon for use in conjunction with said upper wheel, the upper wheel having twelve segments with alternate segments being blank and transparent and the remaining segments having measurement data displayed thereon for use in conjunction with the lower wheel.

### FILING DATE AND NOTICE OF CO-PENDING APPLICAIONS

The applicant claims as a filing date, the date on which this application was received by the United States Patent Office. There are no co-pending related applications filed by the applicant as of the date of filing of this application.

### BACKGROUND

1. Field of Invention

This invention pertains to an instrument for computing proportions or fractions of an originally printed, published or displayed recipe to a fraction of the fixed number of servings indicated by the recipe.

2. Background

In 1936 Lane et al. received U.S. Pat. No. 2,098,394 for a recipe file which was an improved combination of a container, data and index cards useful in the assembly and examination of cooking recipes. Pivotally mounted on an index card by an eyelet was an information disc divided into a series of equal spaces around the periphery to coincide with an opening cut in the top edge of the index card. In 1937, Kohlenberger in U.S. Pat. No. 2,111,268 invented a further improvement in the art of cooking by providing a novel means by which the exact time for cooking various vegetables and the like may be ascertained by a rotatably moving disc with an indicator pointing the vegetable desired. In 1940 Walmsley was issued U.S. Pat. No. 2,190,814 for a reference cabinet which accurately specified the kind and amounts of ingredients for a desired “size” as a measure or weight of a batch or mixture, covering a complete variety of baking formulas and adapted specifically for use in a shop routine. In 1939 Herzog received U.S. Pat. No. 2,150,442 for a calorie counting pivoting wheel or calculator permitting the ready addition of the number of calories contained in combinations of foods in any variety.

In 1947 Torrence received U.S. Pat. No. 2,420,762 for wheeled pivoting device with discs arranged one above the other to indicate the value of vitamins and minerals in certain types of foods. Then, in 1960 Pennington received U.S. Pat. No. 2,956,358 for pivoting wheeled disc device for menu selection wherein weight is given to the chemistry of the foods selected and wherein the use of seasonal foods at the wrong time of year is avoided using the device. A similar nutrition indicating device was described in U.S. Pat. No. 3,977,106 in 1976 where a flat circular chart with a flat wheel rotatably pivoted at each side of the chart wherein foods are colored coded on the chart and the relative quantities of food items to provides specific calories or nutrients is shown. A related device of similar construction was patented in 1977 in U.S. Pat. No. 4,048,477 which issued to Hungerford. The device is a hand held weight control calculator which allows an individual to quickly and accurately determined the daily maximum food calories allowed for maintaining, gaining, or losing weight.

### BRIEF DESCRIPTION OF THE DRAWING

Various objects, features and alternate advantages of the invention will be more fully appreciated as the same becomes better understood with reference to the following detailed description of the present invention when considered in connection with the accompanying drawings, in which:

FIG. 1 is a representation of the preferred embodiment of an instrument for computing proportions of a recipe or recipe sizing wheel, assembled from three concentrically rotating disks, as it appears in actual operation; and

FIG. 2 is a representation of an embodiment of the lowermost or inner disk of the recipe sizing wheel; and

FIG. 3 is a representation of an embodiment of the uppermost or outer disk of the recipe sizing wheel; and

FIG. 4 is cross-section of the preferred embodiment of the instrument for computing proportions of a recipe shown in FIG. 1 taken along the line 4-4′.

### DETAILED DESCRIPTION

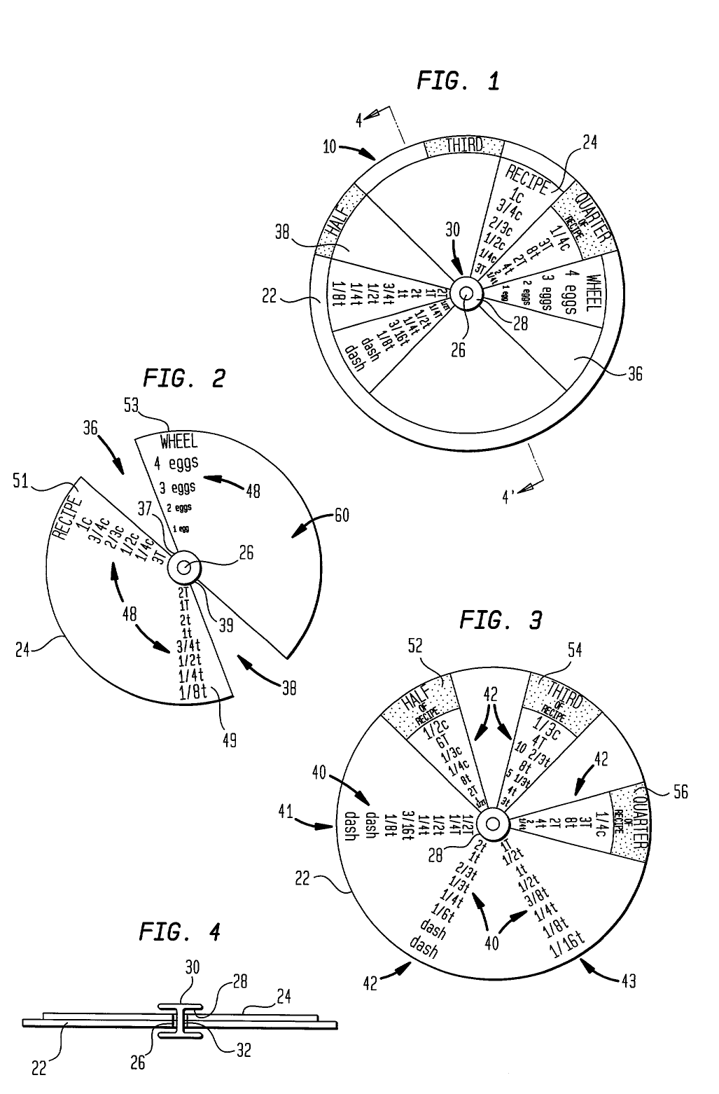

There is shown in FIG. 1 a representation of the preferred embodiment of an instrument for computing proportions of a recipe, namely, a recipe sizing wheel 10, assembled from two concentrically rotating lower and upper disks 22 and 24, as it appears in actual operation. The lower disk 22 is located below or underneath the disk 24. Hence, the upper disk 24 is located above or on top of the disk 22. Each the disks 22 and 24 have central first and second apertures 26 and 28, respectively, adapted to receive a rivet 30.

In FIG. 1 the lower disk 22 and the upper 24 are shown rotably connected to each other via the rivet 30 inserted through concentric apertures 26 and 28.

The recipe sizing wheel 10 is made up of the lower disk 22 as shown in FIG. 3 and the upper disk 24 as shown in FIG. 2. The disks 22 and 24 are connected together in their centers by the rivet 30 as illustrated more fully in FIG. 3. The recipe sizing wheel 10 operates by rotating the upper disk 24 in a prescribed manner with respect to the lower disk 22 to calculate less than full portions or multiples of portions for which a recipe is written or expressed. The recipe sizing wheel 10 allows any cook or chef that uses recipes, whether from a cookbook, magazine, or newspaper, etc. to quickly, effortlessly and accurately reduce or increase the number of servings a recipe prepares.

As illustrated in FIG. 4, the rivet 30 has an elongated shank 32 about which the disk 22 and the disk 24 each freely rotate. The upper disk 24 is approximately 0.125 cm. smaller in diameter, for example, than the lower disk 22. This difference in diameters allows the user to see the designations indicated along the outer 0.125 cm. margin of the lower disk 22. The upper disk 24 has first and second pie-slice shaped windows 36 and 38 as shown in FIGS. 1 and 2. The first and second pie-slice shaped windows 36 and 38 have first and second pointed ends 37 and 39, respectively. The first and second pointed ends 37 and 39 are selectively arranged such that each is near or adjacent the rivet 30.

The upper disk 24 has at least three functionalities, namely, (a) the first pie-slice shaped window 36 and the second pie-slice shaped window 38 each allow access by the user to first and second printed material groups 40 and 44 exhibited on the lower disk 22; (b) the upper disk 24 exhibits a third printed material group 48 in an easy-to-read, easy-to-understand format; and, (c) the upper disk 24 has a relatively large printable area 60 on which may be displayed copyrighted or uncopyrighted directions which succinctly direct how to use the instrument, i.e. the recipe sizing wheel 10. These directions may captioned as follows and comprise or, be selected from the following, to wit:

DIRECTIONS TO REDUCE THE
SERVING SIZE OF ANY RECIPE

| | |
|---|---|
| 1. | Locate reduction amount on bottom wheel. |
| 2. | Position top wheel over shaded or colored area |
| | (the color would be specified). |
| 3. | Locate measurement or number of whole eggs on top wheel. |
| 4. | Use measurement on bottom wheel. |
| 5. | For measurements over 1 cup or 4 eggs, repeat steps 3 and 4. |
| 6. | Repeat steps 3 thru 5 for each ingredient. |
| 7. | For whole egg to egg substitute conversion, use slightly less. |

As further shown in FIG. 1, the lower disk 22 exhibits to a user amounts and measurements for the ingredients in the recipe under construction and which are to be reduced. For example, the first printed matter group 40 comprises three columns 41, 42, and 43 of measurements.

Proceeding from the rivet 28 outward the column 41 shows, for example:

½ T

¼ T

½ t

¼ t

3/16 t

⅛ t

dash

dash

Likewise, the column 42, for example, shows or displays starting from the rivet 28 and at the same corresponding respective specified progressive radial distances, the following:

2 t

1 t

⅔ t

⅓ t

¼ t

⅙ t

dash

dash

Likewise, the column 43, for example, shows or displays starting from the rivet 28 and at the same corresponding respective specified progressive radial distances, the following:

1 T

½ T

1 t

½ t

⅜ t

¼ t

⅛ t

1/16 t

Referring to FIG. 2, there is shown the upper disk 24. The upper disk 24 exhibits to a user amounts and measurements for the ingredients in the recipe under construction in the third printed material group 48. There are shown three columns 49, 51, and 53. For example, the printed matter is depicted in column 49 for use in calculating measurements. Proceeding from the rivet 28 outward at the same aforementioned corresponding respective specified progressive radial distances, the column 49 shows, for example:

2 T

1 T

2 t

1 t

¾ t

½ t

¼ t

⅛ t

The column 51, at its outermost radial location is entitled “RECIPE”, for example, and shows or displays starting from the rivet 28 and at the same corresponding aforementioned respective specified progressive radial distances, the following:

3 T

¼ c

⅓ c

½ c

⅔ c

¾ c

1 c

RECIPE

Likewise, the column 53, for example, shows or displays starting from the rivet 28 and at the same corresponding aforementioned respective specified progressive radial distances, the following, for example:

- - -

1 egg

- - -

2 eggs

- - -

3 eggs

4 eggs

WHEEL

In a recipe, an item such as an orange, an apple, avocado, etc. may selectively be substituted for egg or eggs in the above column.

Referring to FIG. 3, there is shown the lower disk 22. The lower disk 22 further exhibits to a user amounts and measurements for fractional amounts of the ingredients in the recipe under construction in the second printed material group 44. There are shown three columns 52, 54, and 56. For example, the printed matter depicted in column 52 is entitled “HALF” at an outermost radial distance space. The column 52 is for use in calculating measurements for one-half of the recipe. Proceeding from the rivet 28 outward at the same aforementioned corresponding respective specified progressive radial distances, the column 52 shows, for example:

1½ T

2 T

8 t

¼ c

⅓ c

6 T

½ c

the recipe

The column 54, at its outermost radial location is entitled “THIRD”, for example, and shows or displays starting from the rivet 28 and at the same corresponding aforementioned respective specified progressive radial distances, the following:

3 t

4 t

5⅓ t

8 t

10⅔ t

4 T

⅓ c

the recipe

Likewise, the column 56, at its outermost radial location is entitled “QUARTER”, for example, and shows or displays starting from the rivet 28 and at the same corresponding aforementioned respective specified progressive radial distances, the following:

2¼ t

1 T

4 t

2 T

8 t

3 T

¼ c

the recipe

In all cases, it is understood that the above-identified arrangements are merely illustrative of the many possible specific embodiments which represent applications of the present invention. Numerous and varied other arrangements can readily be devised in accordance with the principles of the present invention without departing from the spirit and scope of the invention.

Parts List

recipe sizing wheel 10

lower disk 22

upper disk 24

first aperture 26

second aperture 28

rivet 30

elongated shank 32

first pie-slice shaped window 36

first pointed end 37

second pie-slice shaped window 38

second pointed end 39

first printed material group 40

column 41

column 42

column 43

second printed material group 44

column 52

column 54

column 56

third printed material group 48

column 49

column 51

column 53

large printable area 60

What is claimed is:

1. An instrument for computing proportions of an original displayed recipe to a fraction of a fixed number of servings specified in said recipe comprising:
(a) A substantially round inner wheel;
(b) A substantially round outer wheel;
(c) A means for rotably connecting said inner wheel to said outer wheel, said means being located substantially at the center of each wheel;
the inner wheel being divided into at least first and second 60° sectors, said 60° sectors being diametrically opposite each other, one 120° sector located to the right and in between said first and second 60° sectors diametrically opposite each other, and, one 90° sector located to the left and in between said first and second 60° sectors diametrically opposite each other,
the first 60° sector being equally divided into a 30° sector having an open space left of the remaining 30° sector, and a 30° sector, said sector being the remaining sector and displaying at least eight substantially equally wide concentric radial sectors of an annulus, each substantially equally wide concentric radial sectors of an annulus having its parallel trapezoid sides circularly concentric and each having a linear right radial side extending in between a top side and a bottom side; and, each having a lineal left radial side extending in between the top and the bottom side; beginning from the center of the inner wheel, the first, third, and fifth substantially equally wide concentric radial sectors of an annulus being blank,
the second substantially equally wide concentric radial sector of an annulus having displayed thereon the term “1 egg” or an equivalent food term;
the fourth substantially equally wide concentric radial sector of an annulus having displayed thereon the term “2 eggs” or an equivalent food term;
the sixth substantially equally wide concentric radial sector of an annulus having displayed thereon the term “3 eggs” or an equivalent food term;
the seventh substantially equally wide concentric radial sector of an annulus having displayed thereon the term “4 eggs” or an equivalent food term;
the eighth substantially equally wide concentric radial sector of an annulus having displayed thereon the term “WHEEL” or an equivalent non-food term;
the second 60° sector being equally divided into a 30° sector having an open space left of the remaining 30° sector, and a 30° sector, said sector being the remaining sector and displaying at least eight substantially equally wide concentric radial sectors of an annulus, each substantially equally wide concentric radial sectors of an annulus having its parallel trapezoid sides circularly concentric and each having a linear right radial side extending in between a top side and a bottom side; and, each having a lineal left radial side extending in between the top and the bottom side; beginning from the center of the inner wheel, the first, third, and fifth substantially equally wide concentric radial sectors of an annulus being blank,
the first substantially equally wide concentric radial sector of an annulus having displayed thereon the term “2 T” or an equivalent food measurement term;
the second substantially equally wide concentric radial sector of an annulus having displayed thereon the term “1 T” or an equivalent food measurement term;
the third substantially equally wide concentric radial sector of an annulus having displayed thereon the term “2 t” or an equivalent food measurement term;
the fourth substantially equally wide concentric radial sector of an annulus having displayed thereon the term “1 t” or an equivalent food measurement term;
the fifth substantially equally wide concentric radial sector of an annulus having displayed thereon the term “¾ t” or an equivalent food measurement term;
the sixth substantially equally wide concentric radial sector of an annulus having displayed thereon the term “½ t” or an equivalent food measurement term;
the seventh substantially equally wide concentric radial sector of an annulus having displayed thereon the term “¼ t” or an equivalent food measurement term; and
the eighth substantially equally wide concentric radial sector of an annulus having displayed thereon the term “⅛ t” or an equivalent food measurement term.

2. The instrument according to claim 1 wherein the second 60° sector is located clockwise 120° from the first 60° sector; the 120° sector occupying a circular space of 120° clockwise rotation from the first 60° sector; and, the other 30° sector is located counterclockwise adjacent said first blank space.

3. The instrument according to claim 2 wherein the outer wheel is comprised of not less than twelve segments of a circle wherein alternate segments are blank and the remaining segments each have information displayed thereon and confined in concentric sectors of an annulus.

4. The instrument according to claim 3 wherein said twelve segments are substantially equally spaced apart.

5. The instrument according to claim 4 wherein said twelve segments each occupy 30°

6. The instrument according to claim 5 wherein each of the 30° segments having information displayed thereon and confined in concentric sectors of an annulus further comprises at least nine equally spaced concentric sectors of annuli and wherein a first segment has indicated thereon preceding from an outermost annulus to an innermost annulus the following food measure information in the following sequence: “HALF”, “THE RECIPE”, “½ c”, “6 T”, “⅓ c”, “¼ c”, “8 t”, “2 T”, and “1½ T”.

7. The instrument according to claim 6 wherein a second clockwise segment has indicated thereon, preceding from an outermost annulus to an innermost annulus the following food measure information in the following sequence: “THIRD”, “THE RECIPE”, “⅓ c”, “4 T”, “10⅔ c”, “8 t”, “5⅓ t”, “4 t”, and “3 t”.

8. The instrument according to claim 7 wherein a third clockwise segment has indicated thereon, proceding from an outermost annulus to an innermost annulus the following food measure information in the following sequence: “QUARTER”, “THE RECIPE”, “¼ c”, “3 T”, “8 t”, “2 T”, “4 t”, “1 T”, and “2¼ t”.

9. The instrument according to claim 8 wherein a fourth clockwise segment has indicated thereon, preceding from an outermost annulus to an innermost annulus the following food measure information in the following sequence: “a first blank space”, “1/16 t”, “⅛ t”, “¼ t”, “⅜ t”, “½ t”, “4 t”, “1 T”, and “2¼ t”.
